(19) United States
(12) Patent Application Publication
(10) Pub. No.: US 2021/0045297 A1
(43) Pub. Date: Feb. 18, 2021

(54) INSECT BARRIER SYSTEM

(71) Applicant: Rachel H. Bergey, Harleysville, PA (US)

(72) Inventor: Rachel H. Bergey, Harleysville, PA (US)

(21) Appl. No.: 16/993,395

(22) Filed: Aug. 14, 2020

Related U.S. Application Data
(60) Provisional application No. 62/887,071, filed on Aug. 15, 2019.

(51) Int. Cl. A01G 13/10; A01M 29/34; A01G 13/02

(52) U.S. Cl. CPC A01G 13/105; A01G 13/02; A01M 29/34

(57) ABSTRACT

An insect barrier system configured for positioning about a tree trunk. The system includes a barrier member having an extending portion which includes an inner edge extending along a plane and an outer edge positioned a distance from the plane. The barrier member is configured to be positioned about the tree trunk such that the inner edge is in sealing engagement therewith and a containment area is defined between the extending portion and the tree trunk. A collection sack is configured to be positioned above the barrier member. A tunnel member having a passage therethrough is positioned such that an inlet opening thereof opens into the containment area and on outlet opening thereof opens into the collection sack.

This application claims the benefit of U.S. Prov. Appln. No. 62/887,071, filed Aug. 15, 2020, the contents of which are incorporated herein by reference.

### FIELD

This disclosure relates to an insect barrier system. More particularly, the disclosure relates to a system that prevents insects climbing and infesting trees.

### BACKGROUND

The spotted lanternfly, Lycorma delicatula (White), is an invasive planthopper. Although it has two pairs of wings, it climbs and jumps more than it flies. As such, during their lifecycle, the lanternflies generally climb the trunks of trees to reach higher locations where it feeds and lays eggs.

Spotted lanternflies have been documented to feed on over 70 species of trees and plants. It's the feeding that does the harm. The spotted lanternfly is known as a plant-hopper—they hop around and suck sap from just about anything, including trees, shrubs, and herbs. Both nymphs and adults of spotted lanternfly cause damage when they feed, sucking sap from stems, bark and leaves. This can reduce photosynthesis, weaken the plant and eventually contribute to the plant's death. In addition, feeding can cause the plant to ooze or weep, resulting in a fermented odor, and the insects themselves excrete large amounts of fluid known as honeydew. These fluids promote mold growth and attract other insects.

The spotted lanternfly was first discovered in Berks County, Pennsylvania in 2014. In 2016, the lantern fly infestation covered about 174 square miles. By the end of 2017, more than 3,000 square miles in southeastern Pennsylvania had spotted lanternflies. In the last year, a thriving population of spotted lanternflies were discovered in Virginia for the first time. It is anticipated that if left unabated, the infestation will continue to spread.

Accordingly, there is a need for a system which provides a barrier for the spotted lanternflies to climb and feed on trees. While the disclosure discusses spotted lanternflies, the system described herein is not limited to such and may be utilized to provide a barrier to other tree climbing insects, for example, gypsy moth caterpillars, gypsy moths, cankerworms and winter moths.

### SUMMARY

In at least one embodiment, the present disclosure provides an insect barrier system configured for positioning about a tree trunk. The system includes a barrier member having an extending portion which includes an inner edge extending along a plane and an outer edge positioned a distance from the plane. The barrier member is configured to be positioned about the tree trunk such that the inner edge is in sealing engagement therewith and a containment area is defined between the extending portion and the tree trunk. A collection sack is configured to be positioned above the barrier member. A tunnel member having a passage therethrough is positioned such that an inlet opening thereof opens into the containment area and on outlet opening thereof opens into the collection sack.

In at least one embodiment, the insect barrier system further includes a sealing member extending along the barrier member to create a sealed engagement between the barrier member and the tree trunk.

In at least one embodiment, the insect barrier system further includes a path strip having an insect attracting element thereon. The path strip is configured to be positioned along the tree trunk such that it extends at least from the containment area into the passage.

### BRIEF DESCRIPTION OF THE DRAWINGS

The accompanying drawings, which are incorporated herein and constitute part of this specification, illustrate the presently preferred embodiments of the disclosure, and, together with the general description given above and the detailed description given below, serve to explain the features of the disclosure. In the drawings:

FIG. 1 is an elevation view illustrating an insect barrier system in accordance with an embodiment of the disclosure positioned relative to an illustrative tree.

FIG. 2 is a cross-sectional view along the line 2-2 in FIG. 1.

FIG. 3 is an expanded view as indicated in FIG. 2.

FIG. 4 is a cross-sectional view along the line 4-4 in FIG. 1.

FIG. 5 is a plan view of an illustrative path strip of the insect barrier system of FIG. 1.

FIG. 6 is a perspective view of an illustrative tunnel member of the insect barrier system of FIG. 1.

FIG. 7 is a perspective view of an illustrative barrier member of the insect barrier system of FIG. 1.

FIG. 8 is a perspective view of an illustrative sealing member of the insect barrier system of FIG. 1.

FIG. 9 is a perspective view of an illustrative collection sack of the insect barrier system of FIG. 1 prior to cutting an opening therein and the drawstring in a closed position.

FIG. 10 is a perspective view of the collection sack of FIG. 9 with an opening cut therein and the drawstring in an opened, emptying position.

FIG. 11 is a perspective view of an illustrative barrier member in accordance with another embodiment of the disclosure.

### DETAILED DESCRIPTION OF THE INVENTION

In the drawings, like numerals indicate like elements throughout. Certain terminology is used herein for convenience only and is not to be taken as a limitation on the present invention. It is noted that the drawings may not be drawn to scale. The following describes preferred embodiments of the present disclosure. However, it should be understood, based on this disclosure, that the system is not limited by the preferred embodiments described herein.

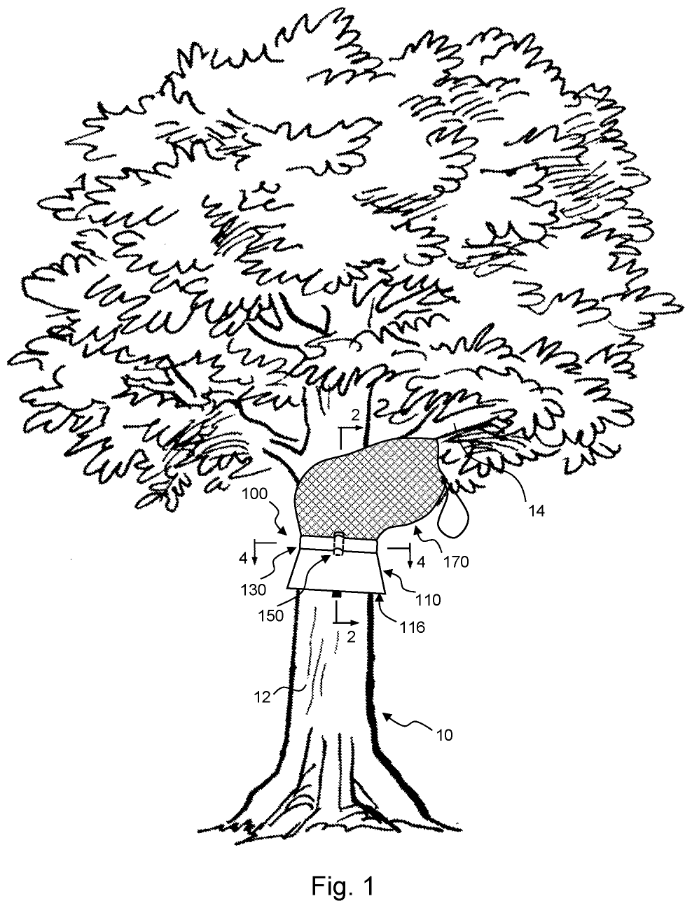

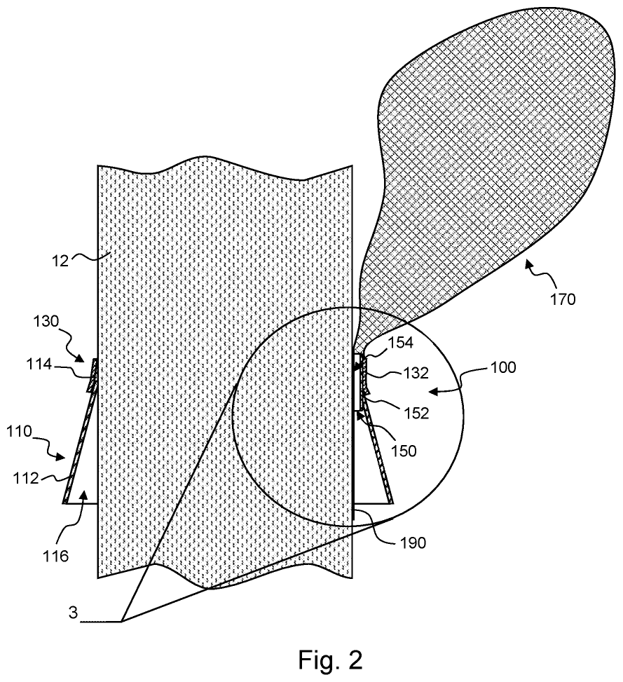

Referring to FIGS. 1-10, an exemplary embodiment of an insect barrier system 100 in accordance with an embodiment of the invention will be described. With reference to FIGS. 1-4, the barrier system 100 generally comprises a barrier member 110 which is secured about the trunk 12 of a tree 10 by a sealing member 130. The barrier member 110 includes a portion 112 which extends away from the tree trunk 12 to define to define a containment area 116 between the barrier member 110 and the tree trunk 12. With the barrier member 110 generally sealed about the tree trunk 12 by the sealing member 130, insects crawling up the tree trunk 12 are prevented from passing beyond the barrier member 110, except through a passage 154 defined by tunnel member 150. The tunnel member 150 includes a body 152, for example, of semi-circular configuration, which extends from within the containment area 116 to upwardly beyond the sealing member 130. The upper end of the passage 154 opens into a collection sack 170 which is sealed about the tunnel member 150. The collection sack 170 may be secured relative to the tree 10, for example, by connection to a branch 14 or the like, to be supported above the barrier member 110. As such, insects climbing the tree 10 will generally be prevented from continuing to climb the trunk, and instead will be funneled through the passage 154 and into the collection sack 170. As illustrated in FIGS. 2 and 3, the collection sack 170 is generally supported away from the tree trunk 12 such that insects therein cannot attempt to eat or bore into the trunk. To assist the insects in moving to and through the passage 154, a path strip 190, with a color, scent or the like that attracts the insect, may be positioned along the trunk 12 and passing through the passage 154.

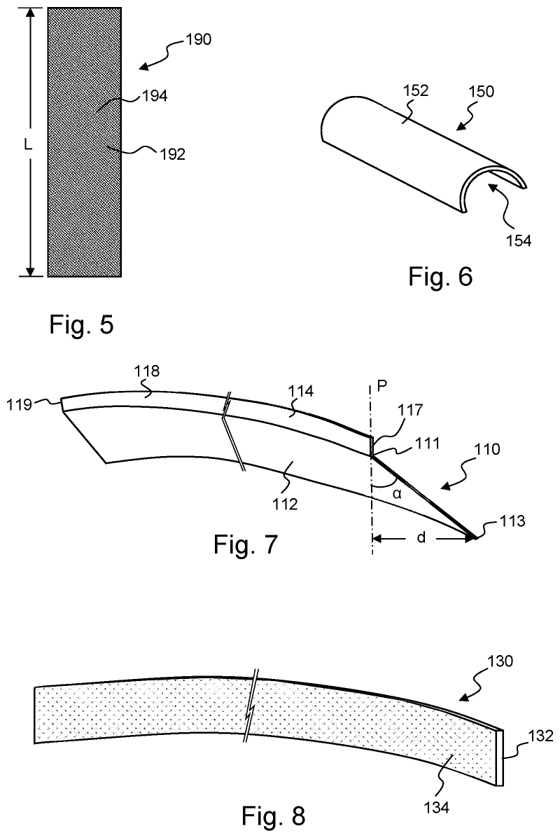

While the general configuration and operation of the insect barrier system 100 are described with reference to FIGS. 1-4, the various components will be described in more detail with reference to FIGS. 5-10. Additionally, illustrative methods of installing the insect barrier system 100 will also be described.

Referring to FIG. 5, an illustrative path strip 190 will be described. The path strip has a body 192 with a length L that is preferably longer than a length of the tunnel member passage 154. In this way, upon assembly, the path strip 190 will extend from at least within the containment area 116 beyond the tunnel member 150. As shown in FIG. 2, the path strip body 192 may be of sufficient length such that the path strip 190 extends beyond the lower edge of the barrier member 110. The outer facing surface 194 of the path strip 190 is configured to attract one or more insects, for example, based on a color or scent provided therealong. As an example, the inventor has found that spotted lanternflies are attracted to dark colors and therefore the outer facing surface 194 may have a black or other dark color surface. The opposite surface (not shown) of the path strip 190 has an adhesive or the like to adhere the path strip 190 to the tree trunk 12 at a desired location.

Referring to FIG. 6, an illustrative tunnel member 150 will be described. The tunnel member 150 includes a body 152 manufactured from a rigid or semi-rigid material such that when the tunnel member 150 is secured to the tree trunk 12, an open passage 154 is maintained between the tree trunk 12 and the body 152. While shown with a semi-circular configuration, the tunnel member body 152 is not limited to such and may have other configurations, for example, rectangular or semi-elliptical. In the application of the system 100 with spotted lanternflies, the passage 154 is an open passage since the spotted lanternflies generally only climb upwards. However, in applications with insects that may climb down at different times of the day or the like, the tunnel member 150 may be formed with a one-way flap (not shown) or the like in the passage 154 to prevent such insects from moving downward through the passage 154.

Turning to FIG. 7, an illustrative barrier member 110 will be described. The barrier member 110 includes an extending portion 112 which extends from an inner edge 111 to an outer edge 113. The inner edge 111 extends along a plane P which is configured to extend along the tree trunk 12. In the present embodiment, the extending portion 112 extends at an acute angle α relative to the plane P such that the outer edge 113 is spaced a distance d from the plane P. As such, when the barrier member 110 is positioned on the tree trunk 12, the containment area 116 is defined between the extending member 112 and the tree trunk 12. While the extending member 112 of the present embodiment is shown extending at an acute angle, the disclosure is not limited to such and the extending member may have other configurations wherein the inner edge 111 is along the plane P and the outer edge 113 is spaced from the plane P. For example, FIG. 11 shows an alternative embodiment of the barrier member 110′ wherein the extending portion 112′ is defined by a first portion 112a which extends at a right angle relative to the plane P and a second portion 112b which extends at a right angle thereto such that the second portion 112b is substantially parallel to the plane P but spaced therefrom a distance d. Other straight, curved or angled configurations may also be utilized.

In the illustrated embodiment, the barrier member 110 includes a flange portion 114 extending upward from the inner edge 111 of the extending portion 112 generally along the plane P. The flange portion 114 is configured to be wrapped around and extend along the tree trunk 12 to provide a surface for a portion of the sealing member 130 to extend along to seal between the barrier member 110 and the tree trunk 12. It is recognized that the flange member 114 may be omitted and the sealing member 130 may extend directly along the extending portion 112. As another alternative, the flange portion 114 may be provided with an adhesive or the like along its inner surface 118 such that the flange portion 114 seals directly to the tree trunk 12 and serves as the sealing member. As yet another alternative, the opposite ends 117, 119 of the barrier member 110 may be provided with connecting members (not shown) which connect with one another such that the flange portion 114 is constricted about the tree trunk 12, thereby providing the necessary sealing without a separate sealing member. The connecting members may include, for example, adhesives, hook and loop fasteners, clips, buckles or straps.

The barrier member 110 may be manufactured from various materials provided the material has sufficient rigidity to maintain the outer edge 113 spaced from the plane P. As non-limiting examples, the barrier member 110 may be manufactured from metal (e.g. sheets or foil), plastic (e.g. thermoplastic or thermoset plastic), rubber, foam rubber, composites or combinations thereof. The barrier member 110 is preferably provided in any desired length between the ends 117, 119 and cut to a length slightly greater than the circumference of the tree trunk 12 such that the ends 117, 119 will overlap when installed. In some applications, it may be desirable to cut an area of the flange portion 114 and possibly the extending portion 112 to provide a notch where the tunnel member 150 passes. As yet another alternative, as illustrated in the barrier member 110′ of FIG. 11, tunnel members 120 defining a passage 121 may be formed into the barrier member 110′, for example within the flange 114′ and first extension portion 112a. Such integrated tunnel members 120 would replace the tunnel members 150. In other aspects, the barrier member 110′ and integrated tunnel members 120 would function in the same manner as described above.

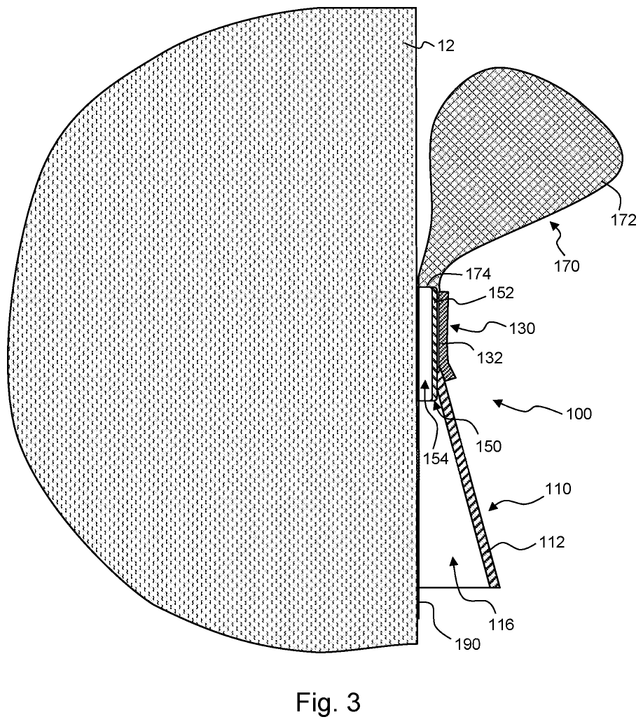

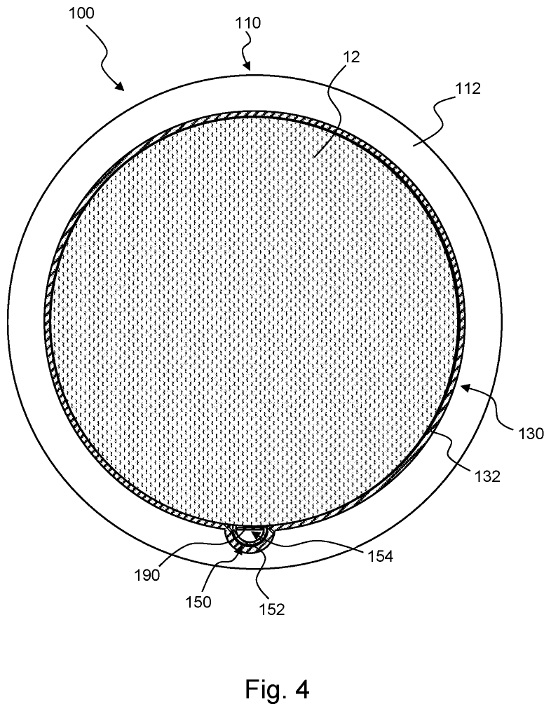

Referring to FIG. 8, an illustrative sealing member 130 will be described. In the illustrated embodiment, the sealing member 130 has a body 132 in the form of an elongate strip. The body 132 has an adhesive 134 applied to the inside surface thereof. Once the tunnel member 150 and the barrier member 110 are positioned about the tree trunk 12, the sealing member 130 is applied such that a portion thereof engages a portion of the barrier member 110, for example, along the flange portion 114, and a portion of thereof adheres to the tree trunk 12, as illustrated in FIGS. 2 and 3. In the area of the tunnel member 150, the sealing member 130 will extend over and around the tunnel member body 152, as shown in FIG. 4, while leaving each of the ends of the passage 154 clear. With the sealing member 130 so positioned, the only upward passage for an insect in the containment area 116 is through the tunnel member passage 154. The sealing member 130 may also be configured to extend over portions of the collection sack 190 to seal such about the tunnel member 150. While the illustrated sealing member 130 is an adhesive strip, it may have other configurations. For example, the sealing member may be in the form of tensioning strap which may extend about the flange portion 114 and constrict such about the tree trunk 12. Other mechanisms may also be utilized.

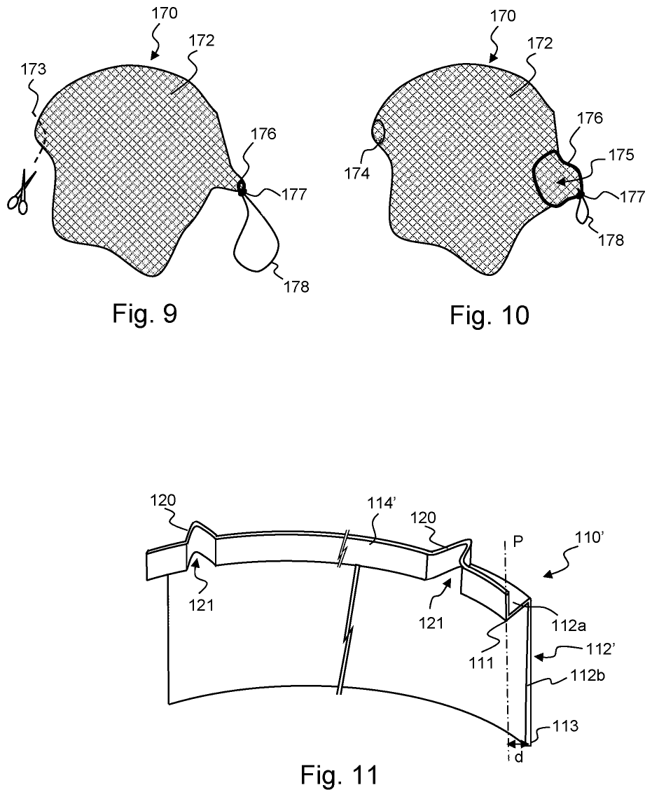

Referring to FIGS. 9 and 10, an illustrative collection sack 190 will be described. The collection sack 190 includes a bag 172 with an interior chamber 175. In the illustrated embodiment, the bag 172 has a mesh configuration which allows a user to see within the chamber 175. The bag 172 may have other configurations which allow a user to see within the chamber 175, for example, a clear plastic material, however, it is also recognized that the bag 172 may be configured that the interior chamber 175 is not visible. The illustrated bag 172 initially does not include an inlet opening therein. To create the inlet opening 174 sized to be positioned about the tunnel member 150, scissors or the like may be used to cut, for example along line 173, to create the opening 174. The collection sack 170 is then positioned with the tunnel member 150 extending into the opening 174 and sealed thereabout. It is recognized that the bag 172 may include a preformed inlet opening.

In the illustrated embodiment, the bag 172 includes a drawstring opening 176 which may be utilized to empty the chamber 175. The drawstring opening 176 includes a drawstring 178 and a lock member 177. In a closed condition illustrated in FIG. 9, the lock member 177 is secured against the opening 176 to close off the opening 176 and prevent insects from exiting the bag 172. Once the bag is sufficiently full of insects, the lock member 177 may be moved along the drawstring 178 to open the opening 176, as illustrated in FIG. 10, to easily empty the chamber 175. Such allows the barrier system 100 to be continuously utilized without the need to replace the whole system or any part thereof after a number of insects have entered, which is often the case with adhesive traps. While a specific drawstring opening 176 is illustrated, such is not required. For example, to empty the chamber 175, a user could cut an opening in the bag (not shown) and then reseal the opening in various ways, for example, tying a knot, bunching and wrapping with a rubber band, or tape.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. An insect barrier system configured for positioning about a tree trunk, the system comprising:
a barrier member including an extending portion which includes an inner edge extending along a plane and an outer edge positioned a distance from the plane, the barrier member configured to be positioned about the tree trunk such that the inner edge is in sealing engagement therewith and a containment area is defined between the extending portion and the tree trunk;
a collection sack configured to be positioned above the barrier member; and
a tunnel member having a passage therethrough, the tunnel member positioned such that an inlet opening thereof opens into the containment area and on outlet opening thereof opens into the collection sack.

2. The insect barrier system according to claim 1 further comprising a sealing member extending along the barrier member to create a sealed engagement between the barrier member and the tree trunk.

3. The insect barrier system according to claim 2 wherein the sealing member is an adhesive strip configured to be positioned with a first portion thereof sealed along a portion of the barrier member and a second portion thereof sealed along the tree trunk.

4. The insect barrier system according to claim 2 wherein the sealing member is a tensioning strap configured to be positioned along a portion of the barrier member and tightened to sealing secure the barrier member about the tree trunk.

5. The insect barrier system according to claim 2 wherein the sealing member is defined by the barrier member.

6. The insect barrier system according to claim 5 wherein the barrier member includes a flange extending from the inner edge of the extending portion and an inner surface of the flange includes an adhesive which acts as the sealing member.

7. The insect barrier system according to claim 5 wherein the barrier member extends between opposed ends and the opposed ends are configured for connection to one another such that the barrier member constricts about and seals relative to the tree trunk.

8. The insect barrier system according to claim 1 further comprising a path strip having an insect attracting element thereon, the path strip configured to be positioned along the tree trunk such that it extends at least from the containment area into the passage.

9. The insect barrier system according to claim 8 wherein the insect attracting element is a color known to attract a target insect.

10. The insect barrier system according to claim 8 wherein the insect attracting element is a scent known to attract a target insect.

11. The insect barrier system according to claim 1 wherein the tunnel member is formed integral with the barrier member.

12. The insect barrier system according to claim 1 wherein the tunnel member is manufactured from a rigid or semi-rigid material.

13. The insect barrier system according to claim 1 wherein the tunnel member has a one-way flap defined therein.

14. The insect barrier system according to claim 1 wherein the extending portion extends from the plane at an acute angle.

15. The insect barrier system according to claim 1 wherein the extending portion includes a first portion which defines the inner edge and extends from the plane at a right angle and a second portion which extends from the first portion to the outer edge, the second portion at an angle of 90° or more relative to the first portion.

16. The insect barrier system according to claim 1 wherein the collection sack includes a sealed opening which may be unsealed to empty the collection sack.

17. The insect barrier system according to claim 1 wherein a collection chamber within the collection sack is visible from outside of the collection sack.

18. The insect barrier system according to claim 17 wherein the collection sack has a mesh configuration.

19. A method of preventing intended insects from climbing a tree trunk, the method comprising:
securing a barrier member, including an extending portion which includes an inner edge extending along a plane and an outer edge positioned a distance from the plane, about the tree trunk such that the inner edge is in sealing engagement therewith and a containment area is defined between the extending portion and the tree trunk;
positioning a collection sack above the barrier member; and
positioning a tunnel member having a passage therethrough such that an inlet opening thereof opens into the containment area and on outlet opening thereof opens into the collection sack.

20. The method of claim 19 wherein the collection sack is positioned such that a collection chamber of the collection sack is spaced from the tree trunk.
